(19) United States
(12) Patent Application Publication
(10) Pub. No.: US 2008/0173145 A1
(43) Pub. Date: Jul. 24, 2008

(54) TOOL DEVICE FOR A PROCESSING MACHINE

(76) Inventor: HSI-KUAN CHEN, Taichung Hsien (TW)

Correspondence Address: MARSH, FISCHMANN & BREYFOGLE LLP, 3151 SOUTH VAUGHN WAY, SUITE 411, AURORA, CO, 80014, US

(21) Appl. No.: 11/625,030

(22) Filed: Jan. 19, 2007

(51) Int. Cl. B23B 3/00

(52) U.S. Cl. 82/117

(57) ABSTRACT

A tool device for a processing machine includes a housing, a tool holder, and a positioning unit. The tool holder includes a first spindle extending into the housing and having a first connecting end. The positioning unit includes a second spindle to rotate along with the first spindle, and an adapter connected to the second spindle opposite to the first spindle and adapted to be connected to the processing machine. The second spindle has a second connecting end surrounding the first connecting end. A releasable interengagement unit interengages the first and second connecting ends so as to connect the second spindle to the first spindle. A bushing is disposed between the first and second connecting ends to center the first connecting end with respect to the second connecting end.

### BACKGROUND OF THE INVENTION

1. Field of the Invention

The invention relates to a tool device, more particularly to a tool device for a processing machine.

2. Description of the Related Art

A conventional tool device provided on a processing machine includes a built-in motor having a high-speed rotational shaft to enable high-speed cutting of a brittle material or an easily deformed plastic material.

Referring to FIG. 1, an existing tool device for a processing machine includes a housing 11, a tool seat 13 having a spindle 12 extending into the housing 11, a positioning unit 14 connected to an end portion 122 of the spindle 12 opposite to the tool seat 13, a built-in motor having a stator 15 disposed in the housing 11 and a rotor 16 sleeved on the spindle 12 and surrounded by the stator 15, and a bearing set 17 disposed on an outer periphery 123 of the spindle 12. The bearing set 17 includes a first bearing group 171 adjacent to the tool seat 13, and a second bearing group 172 adjacent to the positioning unit 14.

When a breakdown of the tool device occurs due to prolonged operation thereof, the entire tool device has to be disassembled from the processing machine for repair or replacement since the components of the tool device are enclosed within the housing 11. For example, if the first or second bearing group 171, 172 is damaged, the entire tool device has to be disassembled, and a new replacement for the damaged first and/or second bearing group 171, 172 is made. As such, the cost of repairing the tool device cannot be reduced.

Further, when a new tool device is to be attached to a machine bed of the processing machine to replace the old tool device, the spindle of the new tool device must undergo positional correction to ensure that the new spindle is located at an accurate position on the machine bed. Therefore, replacement time is prolonged, and losses due to stoppage of the machine are increased.

### SUMMARY OF THE INVENTION

Therefore, the object of the present invention is to provide a tool device for a processing machine that is capable of overcoming the aforementioned drawbacks of the prior art.

According to this invention, a tool device for a processing machine comprises a housing, a tool holder, a positioning unit, a releasable interengagement unit, and a bushing. The tool holder includes a first spindle having a first connecting end, and a tool-clamping head connected to the first spindle. The first spindle extends into the housing. The positioning unit includes a second spindle to rotate along with the first spindle, and an adapter connected to the second spindle opposite to the first spindle and adapted to be connected to the processing machine. The second spindle has a second connecting end surrounding the first connecting end. The releasable interengagement unit is disposed on the first and second connecting ends, and interengages the first and second connecting ends so as to connect the second spindle to the first spindle. The bushing is disposed between the first and second connecting ends to center the first connecting end with respect to the second connecting end.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled schematic view of an existing tool device;

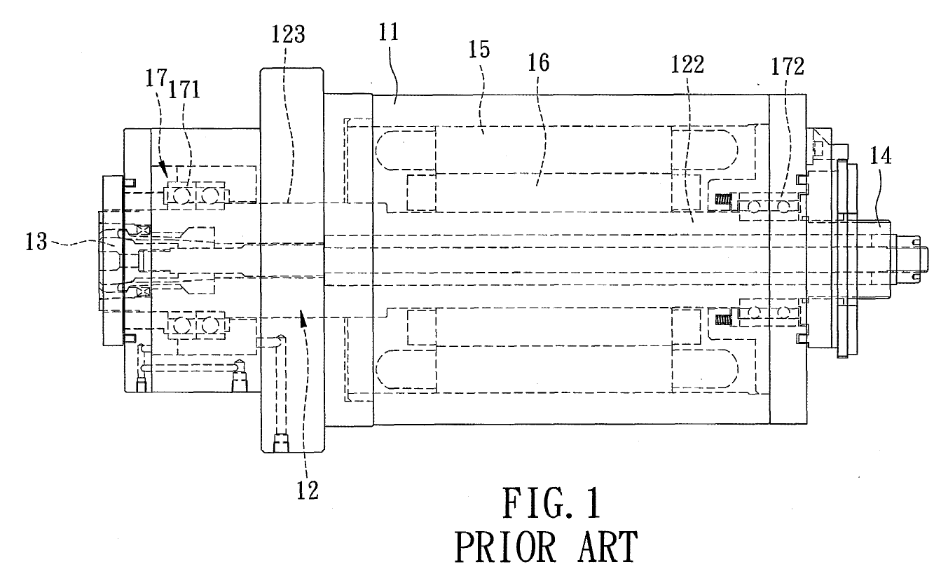

FIG. 2 is an assembled schematic view of the preferred embodiment of a tool device according to the present invention;

FIG. 3 is a fragmentary enlarged sectional view of the preferred embodiment, illustrating a bushing disposed between ends of first and second spindles;

FIG. 4 is a fragmentary exploded perspective view of the first and second spindles, a releasable interengagement unit, and the bushing of the preferred embodiment;

FIG. 5 is a view similar to FIG. 2, but illustrating a cooling liquid unit of the preferred embodiment;

FIG. 6 is a view similar to FIG. 2, but illustrating a cooling air unit of the preferred embodiment; and

FIG. 7 is an exploded schematic view of the preferred embodiment, illustrating separation of a tool holder and a positioning unit from a housing.

### DETAILED DESCRIPTION OF THE PREFERRED EMBODIMENT

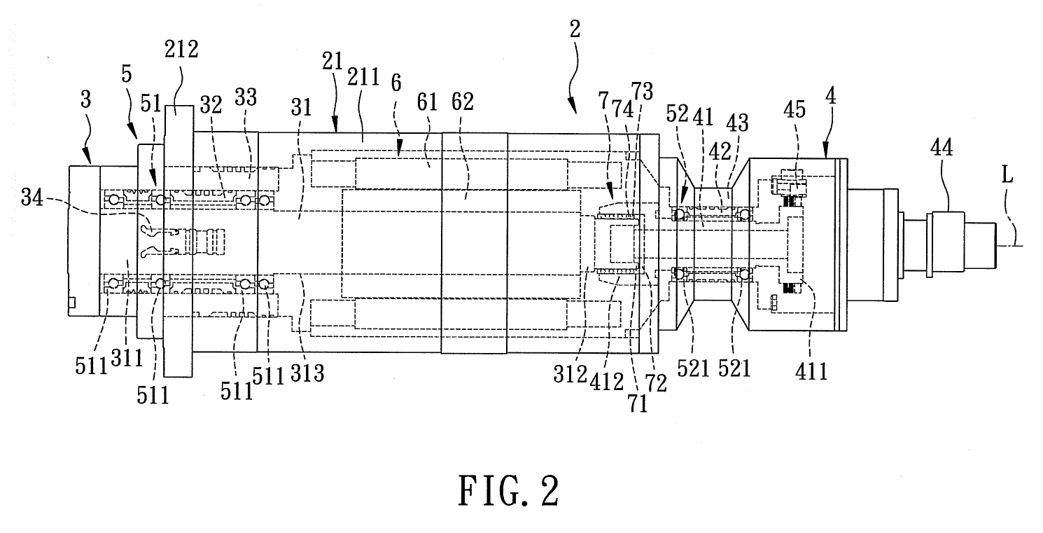

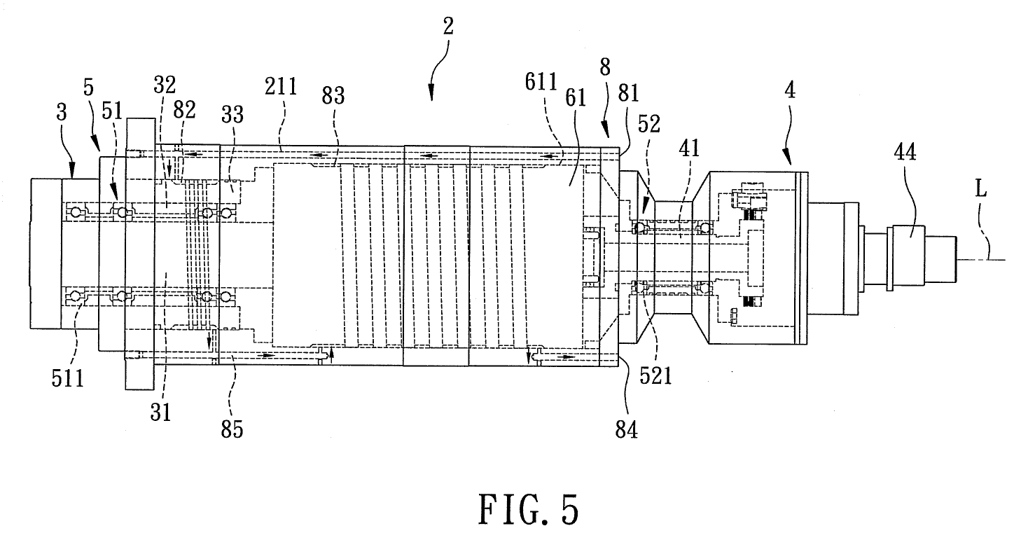

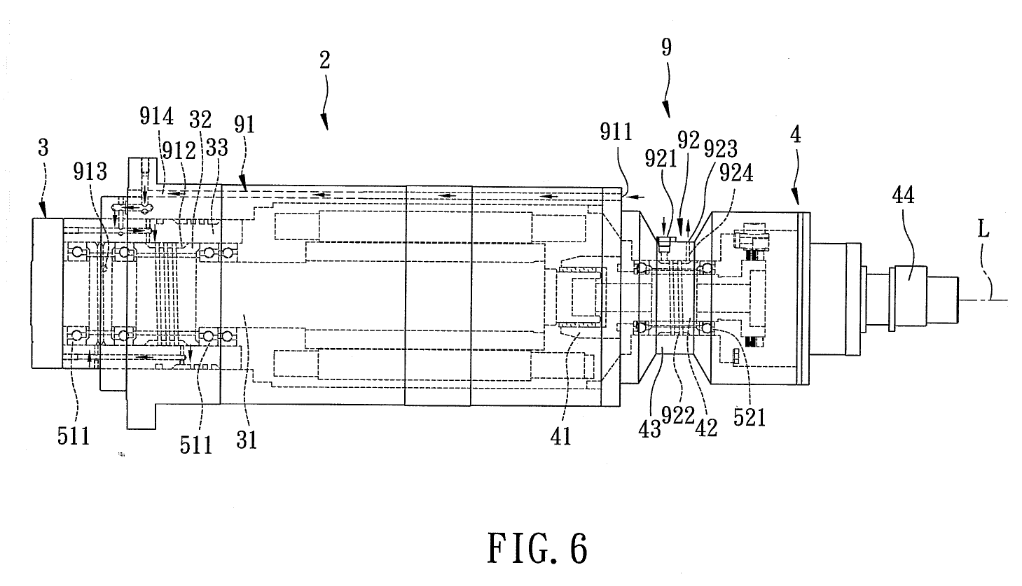

Referring to FIGS. 2 to 7, the preferred embodiment of a tool device 2 according to the present invention is adapted to be suitable for use on a processing machine (not shown), and is shown to comprise a cylindrical housing 21, a tool holder 3, a positioning unit 4, a bearing set 5, a cooling liquid unit 8 (see FIG. 5) and a cooling air unit 9 (see FIG. 6).

The cylindrical housing 21 has an inner surface 211 defining a central axis (L). A flange 212 is connected to the housing 21, and is adjacent to the tool holder 3. In this embodiment, the housing 21 is adapted to be fixed to the processing machine by extending a plurality of screws (not shown) through the flange 212.

The tool holder 3 includes a first spindle 31 extending into the inner surface 211 of the housing 21, an inner tubular wall 32 surrounding the first spindle 31, an outer tubular wall 33 sleeved into the inner surface 211 of the housing 21 and surrounding the inner tubular wall 32, and a tool-clamping head 34 connected to the first spindle 31. The first spindle 31 has a tool-end portion 311 proximate to the tool-clamping head 34, and a first connecting end 312 opposite to the tool-end portion 311. In this embodiment, the outer tubular wall 33 is fixed to the flange 212 through a plurality of screws (not shown).

The positioning unit 4 includes a second spindle 41 extending into the inner surface 211 of the housing 21 to rotate along with the first spindle 31, an inner tubular wall 42 surrounding the second spindle 41, an outer tubular wall 43 connected to the inner surface 211 of the housing 21, an adapter 44 connected to the second spindle 41 and adapted to be connected to the processing machine, and an encoder 45 provided on the outer tubular wall 43. The second spindle 41 has an adapter-end portion 411 proximate to the adapter 44, and a second connecting end 412 opposite to the adapter-end portion 411. The outer tubular wall 43 is fixed to the inner surface 211 of the housing 21 through a plurality of screws (not shown). The second connecting end 412 is stepped, and has an enlarged sleeve portion 4121 coaxial with the second spindle 41 and surrounding the first connecting end 312 of the first spindle 31, and a shoulder formation 4122.

The bearing set 5 includes a first bearing group 51 around an outer wall face 313 of the first spindle 31, and a second bearing group 52 around an outer wall face of the second spindle 41. The first bearing group 51 has four sets of spaced-apart first bearing assemblies 511 disposed in the tool holder 3. The second bearing group 52 has two sets of spaced-apart second bearing assemblies 521 disposed in the positioning unit 4.

A built-in motor that has a stator 61 and a rotor 62 is disposed in the housing 21. The rotor 62 is disposed around the outer wall face 313 of the first spindle 31, and is disposed between the first bearing group 51 and the first connecting end 312 of the first spindle 31. The stator 61 is mounted on the inner surface 211 of the housing 21, and surrounds the rotor 62. When electric power is applied to the stator 61, the rotor 62 rotates through electromagnetic interaction between the stator 61 and the rotor 62 in a high-speed manner around the central axis (L). Thus, the first and second spindles 31, 41 also undergo high-speed rotation.

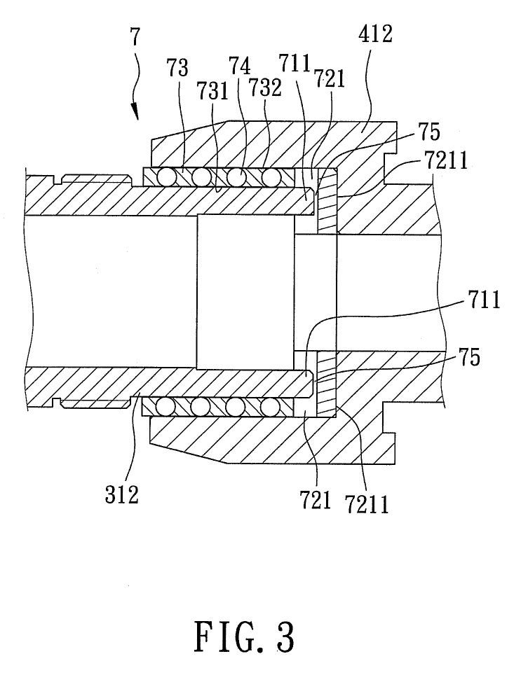

The tool device 2 of the present invention further comprises a releasable interengagement unit 7 disposed on the first connecting end 312 of the first spindle 31 and the second connecting end 412 of the second spindle 41 so as to interconnect detachably the first and second spindles 31, 41. The interengagement unit 7 has a first engaging portion 71 disposed on the first connecting end 312, and a second engaging portion 72 disposed on the shoulder formation 4122 of the second connecting end 412. The first engaging portion 71 has two diametrically opposed protrusions 711 projecting axially from the first connecting end 312. The second engaging portion 72 has a grooved surface 720 facing the first connecting end 312. The grooved surface 720 may be provided directly on the shoulder formation 4122 or on a component provided on the shoulder formation 4122. In this embodiment, the grooved surface 720 is provided on a grooved member 722 attached to the shoulder formation 4122 and having two diametrically opposed grooves 721 extending radially in the grooved surface 720. Each of the grooves 721 has a groove bottom 7211 with a depth larger than a length of each of the protrusions 711 so that a gap 75 (see FIG. 3) is formed between the groove bottom 7211 and the corresponding protrusion 711 when each protrusion 711 engages the corresponding groove 721.

A bushing 73 is disposed between the first and second connecting ends 312, 412, and has inner and outer surfaces 731, 732 respectively contacting the first and second connecting ends 312, 412, and a plurality of rollers 74 retained between and projecting from the inner and outer surfaces 731, 732 of the bushing 73 so as to contact the first and second connecting ends 312, 412, respectively. Each of the rollers 74 may be a steel ball that can be rotated in any direction. Preferably, the rollers 74 have similar diameters.

When the first and second spindles 31, 41 rotate in a high-speed manner, they contact frictionally and respectively the first and second bearing groups 51, 52, and a high temperature is produced that leads to expansion of the first and second spindles 31, 41 axially. However, because of the presence of the gaps 75 between the protrusions 711 and the groove bottoms 7211 of the respective grooves 721, the first and second spindles 31, 41 are prevented from colliding with each other during expansion.

In this embodiment, the first engaging portion 71 and the first spindle 31 are formed integrally, and are made of a material having a first coefficient of elasticity. The second engaging portion 72 is made of a material having a second coefficient of elasticity that is different from the first coefficient of elasticity. Through the different coefficients of elasticity of the first and second engaging portions 71, 72, the protrusions 711 and the grooves 721 can be engaged fittingly.

In an alternative embodiment, the first engaging portion 71 may be provided with two grooves formed in the first connecting end 312 of the first spindle 31, while the second engaging portion 72 may be provided with two protrusions projecting axially from the second connecting end 412 of the second spindle 41.

The cooling liquid unit 8, as shown in FIG. 5, includes a liquid inlet 81, a first liquid annular passage 82 surrounding the first spindle 31 and formed between the outer tubular wall 33 of the tool holder 3 and the inner surface 211 of the housing 21, a second liquid annular passage 83 surrounding the stator 61 and formed between an outer periphery 611 of the stator 61 and the inner surface 211 of the housing 21, a liquid outlet 84, and a liquid flow channel 85 interconnecting fluidly the liquid inlet 81, the first and second liquid annular passages 82, 83, and the liquid outlet 84. Through flowing of cooling liquid between the first and second liquid annular passages 82, 83, heat produced from frictional contact between the first and second spindles 31, 41 and the respective first and second bearing groups 511, 521 during the high-speed rotation of the first and second spindles 31, 41 can be carried away, so that the temperature inside the tool device 2 can be reduced.

The cooling air unit 9, as shown in FIG. 6, includes a first cooling air duct 91 provided in the tool holder 3, and a second cooling air duct 92 provided in the positioning unit 4. The first cooling air duct 91 includes a first air inlet 911, a first annular passage 912 surrounding the first spindle 31 and formed between the inner and outer tubular walls 32, 33 of the tool holder 3, a first air outlet 913, and a first flow channel 914 interconnecting fluidly the first air inlet 911, the first annular passage 912, and the first air outlet 913. The second cooling air duct 92 includes a second air inlet 921, a second annular passage 922 surrounding the second spindle 41 and formed between the inner and outer tubular walls 42, 43 of the positioning unit 4, a second air outlet 923, and a second flow channel 924 interconnecting fluidly the second air inlet 921, the second annular passage 922, and the second air outlet 923. By introducing compressed air directly into the first and second annular passages 912, 922, the heat produced from frictional contact between the first and second spindles 31, 41 and the respective first and second bearing groups 511, 521 can be carried away, so that the effect of cooling the tool device 2 can be achieved.

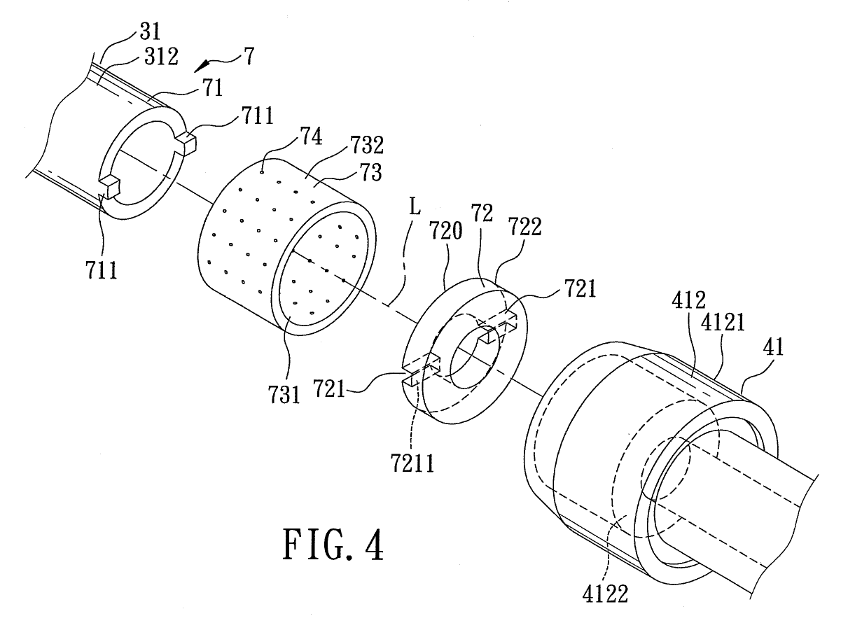

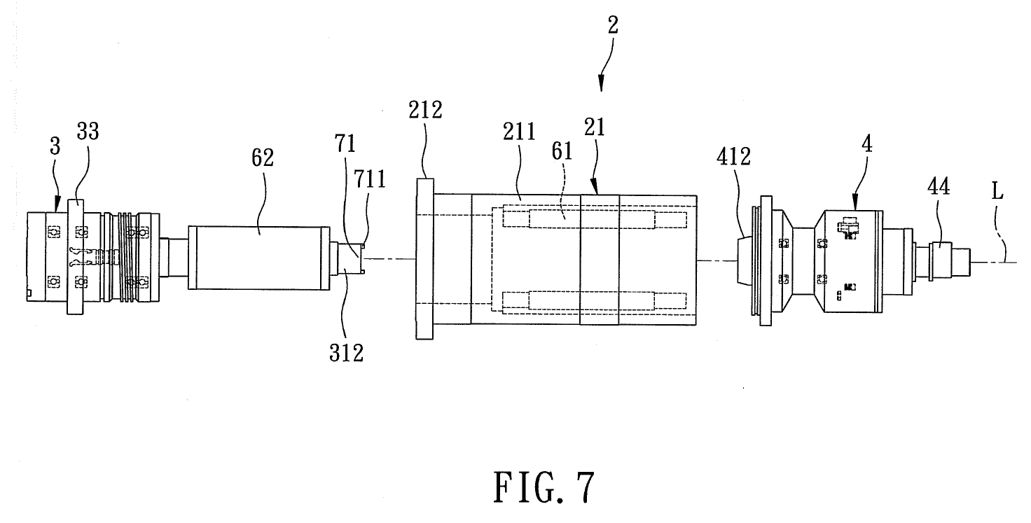

With reference to FIGS. 4 and 7, when the tool device 2 breaks down and needs repair, the damaged component is located first. If the tool holder 3 is found to be defective, the screws (not shown) that fasten the flange 212 to the outer tubular wall 33 of the tool holder 3 are removed, after which the tool holder 3 is forcefully and axially pulled away from the flange 212 until the protrusions 711 are separated from the respective grooves 721. At this time, the tool holder 3 can be entirely pulled out from the housing 21. After the tool holder 3 is repaired or replaced with a new one, the repaired or new tool holder 3 is inserted back into the housing 21, and the tool holder 3 is pushed axially until the protrusions 711 engage respectively the grooves 721. The repaired or new tool holder 3 is then re-attached to the flange 212.

On the other hand, if the positioning unit 4 is found to be defective, the adapter 44 may be detached from the processing machine and the tool holder 3.

It should be noted that since the bushing 73 is provided with a plurality of rollers 74, the first connecting end 312 can be centered with respect to the second connecting end 412 when the first and second connecting ends 312, 412 are interengaged. Thus, when the first spindle 31 is pulled out for repair or replacement, the second spindle 41 can remain in an original corrected position on a machine bed of the processing machine, so that there is no need to conduct again a correction for positional accuracy when the repaired or new first spindle 31 is re-assembled on the processing machine. Furthermore, as the bushing 73 is provided with the rollers or steel balls 74, the bushing 73 permits the first spindle 31 to be easily pulled away from the second spindle 41 in an axial direction although the bushing 73 is inserted fittingly between the first and second connecting ends 312, 412.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A tool device for a processing machine, comprising:
a housing;
a tool holder including a first spindle having a first connecting end, and a tool-clamping head connected to said first spindle, said first spindle extending into said housing;
a positioning unit including a second spindle to rotate along with said first spindle, and an adapter connected to said second spindle opposite to said first spindle and adapted to be connected to the processing machine, said second spindle having a second connecting end surrounding said first connecting end;
a releasable interengagement unit disposed on said first and second connecting ends and interengaging said first and second connecting ends so as to connect said second spindle to said first spindle; and
a bushing disposed between said first and second connecting ends to center said first connecting end with respect to said second connecting end.

2. The tool device of claim 1, wherein said bushing has inner and outer surfaces respectively contacting said first and second connecting ends, and a plurality of rollers retained between and projecting from said inner and outer surfaces to contact said first and second connecting ends, respectively.

3. The tool device of claim 2, wherein each of said rollers is a ball.

4. The tool device of claim 2, further comprising a built-in motor, which includes a rotor disposed around said first spindle, and a stator mounted on an inner surface of said housing and surrounding said rotor.

5. The tool device of claim 4, wherein said second connecting end of said second spindle is stepped, and has an enlarged sleeve portion coaxial with said second spindle and surrounding said first connecting end, and a shoulder formation, said releasable interengagement unit having a first engaging portion disposed on said first connecting end, and a second engaging portion disposed on said shoulder formation.

6. The tool device of claim 5, wherein said second engaging portion includes a grooved surface facing said first connecting end, and at least one groove extending radially in said grooved surface, and said first engaging portion has at least one protrusion projecting axially from said first connecting end into said groove.

7. The tool device of claim 6, wherein said groove has a groove bottom with a depth larger than a length of said protrusion so that a gap is formed between said groove bottom and said protrusion.

8. The tool device of claim 6, wherein said first engaging portion is made of a material having a first coefficient of elasticity, and said second engaging portion is made of a material having a second coefficient of elasticity that is different from said first coefficient of elasticity.

9. The tool device of claim 1, wherein said tool holder further includes an inner tubular wall surrounding said first spindle, and an outer tubular wall sleeved into an inner surface of said housing and surrounding said inner tubular wall.

10. The tool device of claim 9, further comprising a cooling air unit which includes a first cooling air duct provided in said tool holder, said first cooling air duct including a first air inlet, a first annular passage surrounding said first spindle and formed between said inner and outer tubular walls of said tool holder, a first air outlet, and a first flow channel interconnecting fluidly said first air inlet, said first annular passage, and said first air outlet.

11. The tool device of claim 10, wherein said positioning unit further includes an inner tubular wall surrounding said second spindle, and an outer tubular wall connected to an inner surface of said housing and surrounding said inner tubular wall of said positioning unit.

12. The tool device of claim 11, wherein said cooling air unit further includes a second cooling air duct provided in said positioning unit, said second cooling air duct including a second air inlet, a second annular passage surrounding said second spindle and formed between said inner and outer tubular walls of said positioning unit, a second air outlet, and a second flow channel interconnecting fluidly said second air inlet, said second annular passage, and said second air outlet.
